(19) United States
(12) Patent Application Publication
(10) Pub. No.: US 2006/0130997 A1
(43) Pub. Date: Jun. 22, 2006

(54) Vehicle heating, cooling and drying conditioner for apparel

(75) Inventor: Steven B. Marshall, Oxford, MI (US)

Correspondence Address: Valeo Climate Control Corp.;Intellectual Property Department, 4100 North Atlantic Boulevard, Auburn Hills, MI, 48326, US

(73) Assignee: Valeo Climate Control Corp., Auburn Hills, MI (US)

(21) Appl. No.: 11/021,906

(22) Filed: Dec. 22, 2004

(51) Int. Cl. B60H 1/00

(52) U.S. Cl. 165/41

(57) ABSTRACT

The present invention relates to an HVAC pre-conditioning system for vehicles, and, especially, automotive vehicles in the automotive and/or truck sector, which utilizes an HVAC unit, distribution system, and a device, such as ducts, useful for pre-conditioning via heating, cooling or drying material, equipment or apparel. By providing for a preconditioning system comprising at least one rear HVAC system and at least one duct or branch off of the a rear HVAC distribution system, conditioned or conditioning air can be used to pre-condition a number of sports, utility, and other materials such as clothing or other apparel, such as ski-boots, snow boots, walking shoes, working shoes and/or boots, gloves, hats, clothes and leg and body garments (children's snow-suits and scarves) are also envisioned. Other types of equipment, such as water skiing equipment with suitable catch trays, etc., could be dried out or made more comfortable using the present invention.

### FIELD OF THE INVENTION

The present invention relates to vehicles, and, especially, automotive vehicles in the automotive and/or truck sector, with HVAC distribution systems useful for heating, cooling or drying apparel.

### BACKGROUND OF THE INVENTION

Passengers in automotive vehicles have often experienced the problem of wet or frozen forms of apparel which they have maintained on their person on in the back of vehicles to avoid either wear of such wet and or frozen, uncomfortable pieces of clothing, or to dry out such articles of clothing or other such items prior to repeated use. In fact, though often apparel has been dried and/or warmed via alternative methods (sunlight, outside heat generating devices, other devices outside of the motor vehicle, etc.) there has not been an outpouring of commercially available add on/ vehicular designed equipment for the SUV, truck, or work-mans vehicle, and, particularly no such device built in for pre-warming, drying, or cooling such apparel. Present day solutions to uncomfortable apparel brought upon my moisture, and, in particular, cold or frozen moisture, has been to place or throw apparel in the foot-well region of the vehicle (either front or rear), and leave it there until natural methods over time dried them out. One solution has been to crank up the heat in the vehicle to cause the boot or the cockpit of the vehicle to become super heated, and, thus, drive the moisture out of the apparel. However, this system has the disadvantage that the passenger would often become uncomfortable with the excess heat/cooling from the HVAC system since it the HVAC system has not been designed and has not been targeted and/or efficiently arranged to provide for use of heat/cooling in drying/warming or cooling the from such HVAC system which was not designed to work with such apparel.

### SUMMARY OF THE INVENTION

The present invention relates to a pre-conditioning system based on using HVAC technology designed to target and/or efficiently use the HVAC system to provide for heating, cooling, drying or warming of materials using a specific device as part of the pre-conditioning system of a motor vehicle. Whereas such as system could be conceived to provide for a certain climate control in a specific area for a number of purposes, it is especially useful in providing for a way of treating moisture exposed or ridden materials, such as clothing and other wearing apparel, that have been chilled, heated, wetted or dampened prior to entry into the vehicle.

In preferred embodiments of the present invention, such a system, with such an incorporated device, could be used, for example, in preparation of ski-outings or work sites while the car or truck or other such motor vehicle is driving to the ski area. During the time it takes to reach the skill area, the present invention may be used to pre-condition, such as warm a variety of materials, and, in particular, clothing or other apparel, such as ski-boots, snow boots, walking shoes, working shoes and/or boots. In other preferred embodiments of the present invention, the pre-conditioning system, with its specific incorporated device, could be used to pre-condition or dry out clothing or apparel or the like so that the clothing or apparel, when moist, damp, wet from perspiration or exterior sources, that often are found with the general sporting activities, such as gloves, hats, clothes and leg and body garments (children's snow-suits, hats, gloves, scarves) are also envisoned. Other types of materials, such as water skiing equipment with suitable catch trays, etc., could be dried out or made more comfortable using the present invention. In more preferred embodiments of the present invention, the HVAC pre-conditioning system is arranged to enable both storage and pre-conditioning of material, equipment and apparel, in a neat and organized fashion in the rear of the vehicle.

The present invention can utilize air that goes through the HVAC unit after conditioning (conditioning air). In preferred embodiments of the present invention, the HVAC unit may be part of a front unit or a back (rear) unit. In more preferred embodiments, for reason of reduction in complexity, use of less materials, and to allow unused or available space in the back to be utilized, a rear HVAC unit can be used as part of the pre-conditioning system. Of course, although the cool air part of the rear HVAC unit provides for preferred results for many uses, due to its outputted air of low humidity and heat, both the cool air path of the rear HVAC (after air has passed by or through the evaporator and become ‘moisture reduced’ or ‘dried’), and the hot air path (after air has passed through or by the heater core and become ‘warmed’), in preferred embodiments, provides for conditioning air to pre-condition (warm and/or dry air heat or dry) apparel in need of pre-conditioning.

In a preferred method of the present invention, conditioned air, either heated or cooled, or both, passes through the HVAC unit before being distributed into a series of ducts to perform a pre-conditioning for material or apparel in the motor vehicle. Preferred embodiments of the present invention would, therefore, prove useful for work people, sporty people, vacationers, activity trainers and patrons and others to pre condition (dry and warm) their apparel. Specifically, persons knowing that they might need ski boots, snowboard boots and gloves, prior to arrival at the slopes/workplace/walking trails, outdoor or indoor humid or cool or hot regions, leisure facilities or like place, where apparel could become moist, damp or wet, could find a system such as disclosed herein, to pre-conditioned such material, equipment or apparel, to be quite useful. In addition, the preferred embodiments of the present invention allow apparel to be further pre-conditioned, i.e. dried and/or warmed after using the apparel on the appropriate activity. Pre-conditioning means that the equipment/material/apparel are in a more ready state for the next use after being pre-conditioned in the motor vehicle, and, particularly, when lack of such pre-conditionment would lead to discomfort while wearing or using the above.

In preferred embodiments of the present invention, the invention presents a major advantage over the prior art in that apparel so conditioned will be in a more suitable state for re-use (from the point of view of workman, skier, snowboarder, activity person, traveler or the like whom has wet, moist or damp apparel) during and after use and prior to use again the next time/session/day. The preferred embodiments of the present invention, by providing pre-condition, also fully or partially eliminate the need for direct drying or warming of material, equipment, and, especially, apparel, in the home, hotel, residence or place of work.

The present invention envisions numerous types of equipment, materials and apparel that can be pre-conditioned by the pre-conditioning system and by pre-conditioning methods. Non-limiting examples of such equipment, materials and apparel include: apparel such as footwear (walking boots/shoes, sneakers, ski-boots (preferably), snowboard-boots (preferably), work boots, waders, or general or sport or activity like foot attire) and clothing (jackets, tops, sweat-tops, leggings, snow-pants (preferable), snow-suits or accessories (hats, gloves, scarves, face shields, muffs, mittens etc).

The present invention provides for a pre-conditioning system for pre-conditioning materials, equipment and apparel, preferably materials and apparel, more preferably apparel, in a way to provide for such pre-conditioning during the operation of the vehicle. The materials, equipment and apparel is more ready for next time usage than if left wet or moist in the vehicle. Another advantage of the present invention is that children will be more comfortable in cold/wet environments, if the parents/guardians can attempt to, or specifically pre-condition (make dry, warm or make more dry or warm than previously) the apparel the children have been wearing without having to remove the material, equipment of apparel from the motor vehicle. Also, in preferred embodiments, no secondary source of pre-conditioning energy outside of that from the HVAC unit, need to be used. Pre-conditioning can run at any time the motor vehicle's HVAC unit is working, and, of course, quite beneficial, for example, in going from home or hotel to the ski slope or toboggan run.

### BRIEF DESCRIPTION OF THE DRAWINGS

FIG. 1 is a schematic view of ducts and branches for pre-conditioning apparel, in accordance with an aspect of the present invention

FIG. 2 is a schematic view describing a further embodiment of the pre-conditioning function, in accordance with an aspect of the present invention

FIG. 3 is a schematic view of the ducts and branches of the pre-conditioning systems, with typical dimensions as found, in accordance with an aspect of the present invention

FIG. 4 is a schematic view of the pre-conditioning system, including the vehicle interior, rear HVAC unit, HVAC distribution, device and branches with equipment to be pre-conditioned, in accordance with an aspect of the present invention.

FIGS. 5a and 5b are schematic views of a cold or warm box used in the preconditioning system, in accordance with an aspect of the present invention.

FIGS. 6a and 6b are schematic view of a preconditioning system, in accordance with an aspect of the present invention.

FIGS. 7a and 7b are schematic views of a preconditioning system and a boot with stand, in accordance with an aspect of the present invention.

### DETAILED DESCRIPTION OF THE PREFERRED EMBODIMENTS

In preferred embodiments of the present invention, a vehicle comprising an HVAC unit, and, more preferably, a rear HVAC unit, a device such as a duct or, preferably, a plurality of ducts, more preferably a duct or, preferably, a plurality of ducts from a rear HVAC unit, is provided. The HVAC unit and the device having at least one duct comprise an HVAC preconditioning system. Preferably, the duct has at least one branch, more preferably, two or more branches. The ducts of the preferred embodiment of the present invention can be single or multiple piece, preferably multiple piece ducts. By multiple piece, the ducts of the present invention can have detachable and/or interchangeable components, for example, a duct may be assembled using the components to form an angular, straight or curved path, depending on the configuration necessary to pre-condition the material, equipment or apparel necessary. For example, when using a preconditioning system of the present invention wherein a multitude of gloves and or boots need to be dried or warmed, a multitude of ducts and, preferably, branches of the ducts can be provided to condition the multitude of gloves and boots. When the need is to provide certain atmospheric drying or cooling conditions for one piece of equipment, such as a cold box or the like, the number of ducts and/or branches that provide conditioning air may be limited, i.e. a smaller number of ducts and/or branches used or provided, or a single duct or a single branch of a duct my provide conditioning air directly to the equipment or material, as necessary.

Also in preferred embodiments of the present invention, the ducts may have multiple branches that may be open or closed, depending on the need for condition for the particular material, equipment or apparel. For example, access to the branches themselves, and/or to a duct itself may be provided. More preferably, the branch or duct may have a mechanism to open or close a portion of the duct or branch to conditioning air flow, as necessary. The mechanism can be manual or automatic, most preferable the mechanism is mechanical (such as a cap or valve or flap or other such device) capable of shutting off or opening up conditioning air flow to the material, equipment or apparel from the HVAC unit duct or branch, as needed.

The HVAC preconditioning system of the present invention works in conjunction with various modes of the HVAC system. The HVAC system can, preferably, be in a fresh air mode, a recirculation mode or in a partial fresh/recirculation mode, depending on the conditions required. In preferred embodiments of the present invention, the HVAC preconditioning system is designed in a way to have an additional or a ‘third mode’ (first two being panel and floor modes normally for the preferred rear HVAC) and a drying type mode.

In preferred embodiments of the present invention, the device of the invention consists of at least one duct, and preferably, a plurality of ducts. The duct or ducts preferably have at least one branch or branches off of the duct or ducts for the air of the airflow from the HVAC unit to pass therethrough. Particularly preferred is ducts or branches of the ducts that are located on the duct end in an orientation suitable for use for preconditioning of the material, equipment, or apparel, as necessary. Either the duct or ducts and/or the branch or branches of the duct or ducts are, preferably, located in the rear luggage area or trunk region (if any) of the vehicle such that the material, equipment or apparel can be exposed directly to the air flowing through the duct or the branch to an open end of the duct of the branch where the material, equipment or apparel can be preconditioned. In the case of apparel such as foot apparel, the foot apparel could preferably be ‘inverted’ or placed upside down or sideways of the duct or branch open ends. Even more preferably, the foot apparel can be placed on a duct or branch at an angle that follows the angle of the duct or branch end where the duct or branch opens. More preferably, the duct or branch end can be positioned to be in a vertical orientation as it relates to the horizontal or ground, and the branch or branch with opening of the duct or branch, would accept the apparel to be placed in a similar relationship over the duct or branch open ends.

By placing the apparel wherein the opening or end of the duct or branch is in line with the opening or end of the shoe, boot, glove, or other similar apparel, for example, inserted into or at the shoulder or chest area of a sweater, coat, jacket, etc. or at the opening of the shoe, boot, glove, or other apparel, the duct and/or duct branches allow for the apparel to be hung or positioned such as to allow the air from the duct or branch to circulate, pass through, or otherwise pass over the apparel so that it pre-conditions the apparel via a drying and/or cooling process. In preferred embodiments of the present invention, the open ends of the ducts or branches of the ducts, could be placed in such a fashion as to allow for upward pointing or ‘upended’ ducts useful to pre-condition head gear (including hats, helmets and masks) or hand gear (including gloves and handwarmers) drying. The ducts, branches or ends of ducts would be such that they allow air from the airflow to enter and escape or exhaust easily from the apparel. In particularly preferred embodiments, ducts or branches are so aligned so that there is always the possibility for air to flow through or around the material, equipment or apparel, thereby avoiding the situation whereby apparel that is substantially airtight (i.e. tight weaved materials or solid materials) might unintentionally completely block off or choke or otherwise substantially hinder the free flow of drying or warming conditioning air.

The invention is driven by the currently designed preferable rear HVAC. Typically the vehicle segment or class which has the rear HVAC is usually a multi people carrier, SUV or truck. Such vehicles are used in more extreme weather transportation where the end user is interested in extended features to assist their comfort prior to and after partaking their said sport or activity. The current preferable rear HVAC is more than suitable with respect to design to add such functionality. The addition of such functionality is straight forward in a new design, an additional door position of the mode door, and or ‘wind blown self sealing flap’ could be added on the heater core exit side for example. The additional cost would be in a very simple set of blow-molded, injection molded or the like, such ducts or conduits. These ducts being removable and re-connectable to the preferable rear HVAC for summer storage.

The invention consists of a duct or ducts or conduit or conduits, with a branch or branches which feed appropriate amounts of hot, warm, dry air to the ends of the branches. The branch ends are situated such that apparel (preferably ski boots and gloves and hats) can be positioned, placed or pushed over the branches, such that the appropriate amount of hot, warm, dry air feeds into and specifically escapes from said apparel taking with it moisture, damp or wet air.

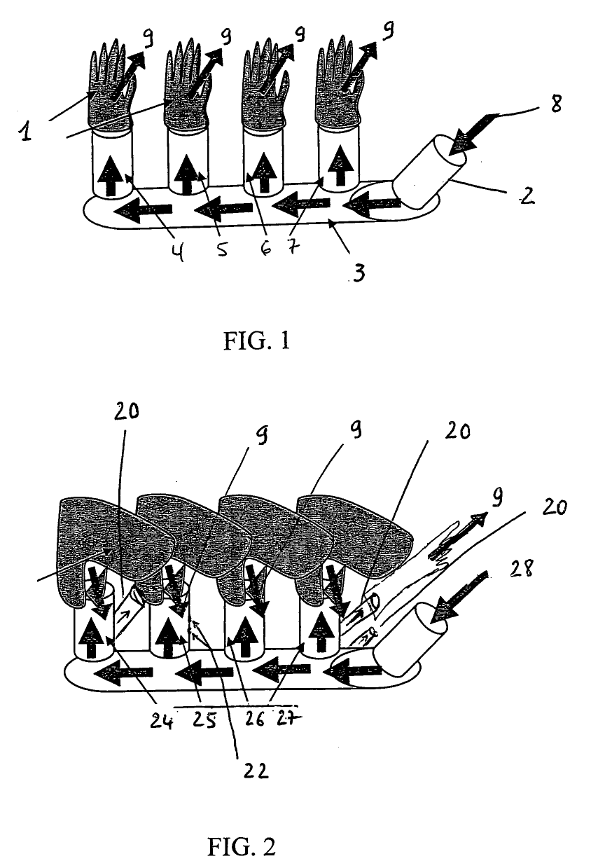

FIG. 1 illustrates a preferred embodiment of the present invention wherein glove apparel is illustrated. By using the heating and cooling capacity of the rear HVAC unit (not shown) in a vehicle such as a sport utility vehicle or minivan, for example, designed ducts (2), duct work (3) and branches (4,5,6,7) allow conditioned air 8 to be feed from the HVAC unit, through the ducts (8,3) and branches (4,5,6,7) and pass through the apparel (1) placed on the branches (4,5,6,7) of the duct (3). This concept, though not illustrated, can relate not only to boots and or gloves, but extended to a coat rack or racks, and snow suit or suits, or other apparel. Conditioning air, after passage through ducts 9 and, gloves, leaves via pores in apparel.

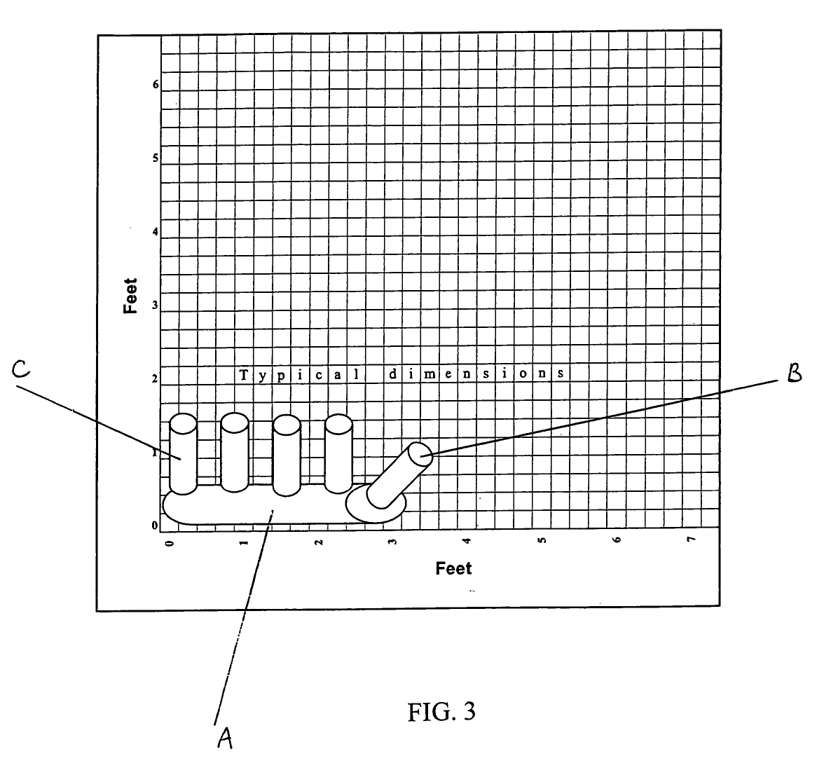

In preferred embodiments of the present invention, as in FIG. 2, the branches bifurcate in a T (24,25,26,27) or Y (20) fashion. The branches, along, preferably, with their bifurcations, be integrally molded as an additional slot in additional feature for storage/drying warming of clothing. The T or Y type of bifurcation (though branches and ducts are not specifically limited to these shapes), is, in preferred embodiments, permeable, i.e. can be perforated (22) or the like, such that warm, dry air passes easily into the whole of the garment of the apparel.

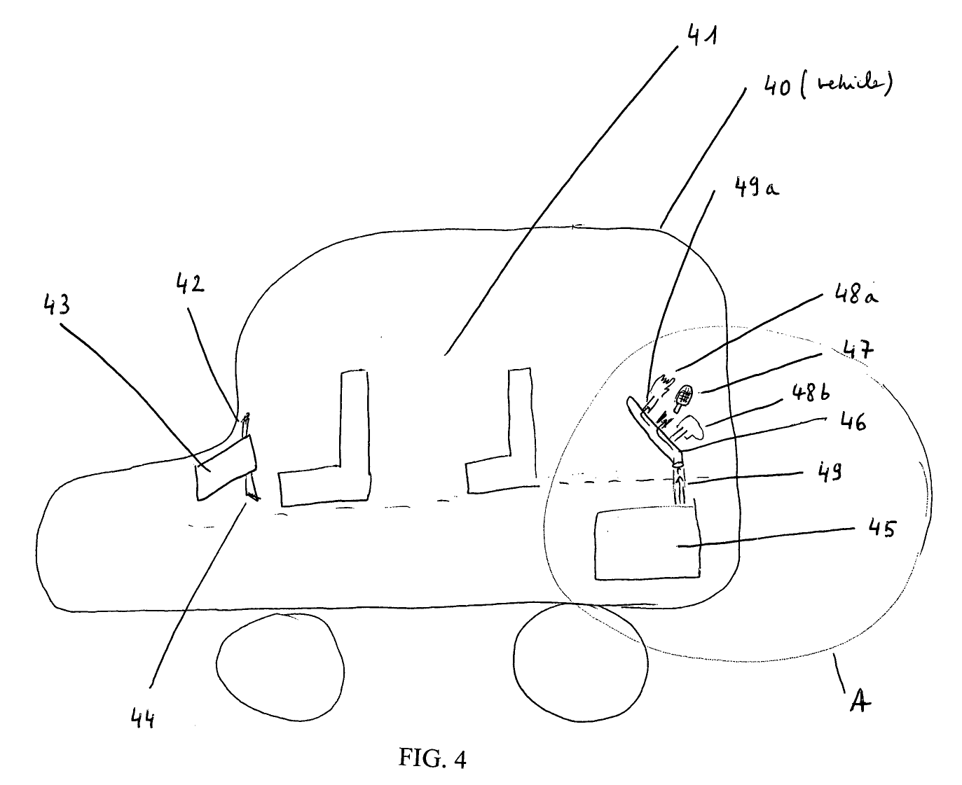

FIG. 3 illustrates typical dimension of ducts A, branches C and main connector to HVAC unit conditioning air B in graphic form.

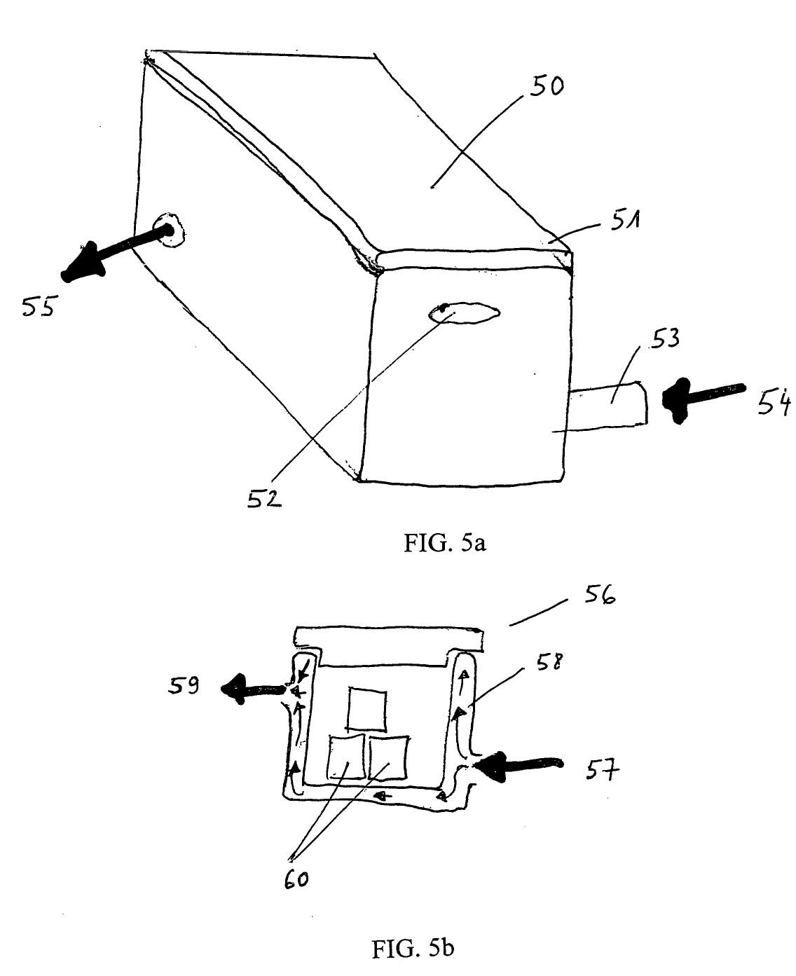

Referring to FIG. 4 is shown an automotive vehicle (40) with front HVAC unit (43), with floor (44) and defrost (42) outlets. The pre-condition system A has rear HVAC unit (45), device (46) with conditioning air stream (49) leading to a conditioning air at branches (49a) apparel (48a) and (48b) and equipment (47) in the rear compartment of the passenger vehicle.

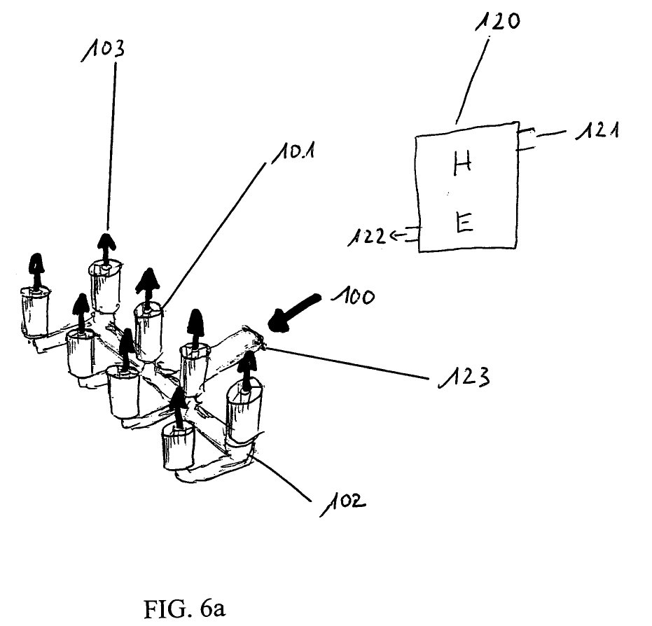

Referring to FIG. 5a a cool box (50) having a lid (51) and carrying handle (52) is provided with a feed duct (53) from the pre-conditioning system providing conditioning air (54) to cool the contents of the cool box (50). (50) could also be a warmer or warmbox, wherein the conditioning air (54) is warm air exhaust port (55) allows release of conditioning air from the system.

FIG. 5b illustrates the cool or warmbox (56), with conditioned or conditioning air (57) flowing around the exterior of the box (58), and exhaust or spent air (59), exhausted from the system. Food, medical supplies or other content (60) that need to be kept under specific temperature and/or moisture conditions, are shown in box (56).

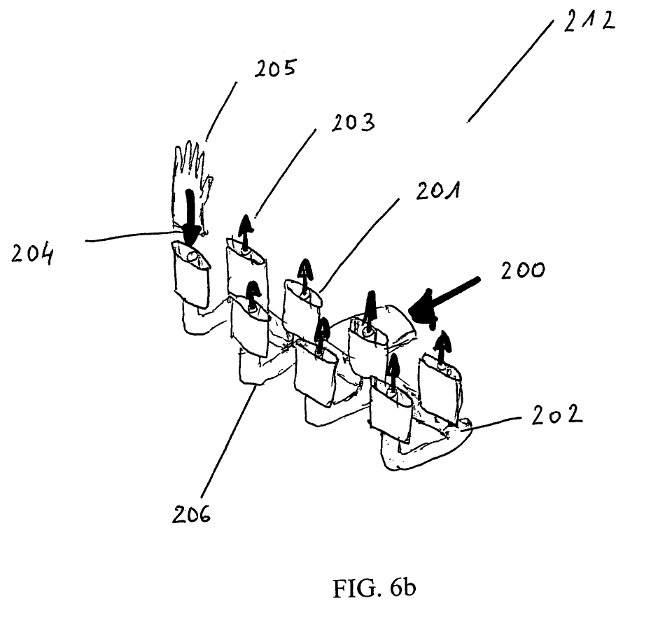

Referring to FIG. 6a, auxiliary HVAC unit 120 has inlet 121 for air prior to conditioning, with heater core H and evaporator E and outlet 122, conditioned air from outlet 122 provided or fed to main connector or coupling 123, to supply conditioning air 100 to ducts 102 and branches 101 adapted for fitting of equipment or apparel (not shown) Conditioning air leaves branches as 103.

FIG. 6b shows similar system, with auxiliary front HVAC unit not shown, condition air 200 for HVAC unit supplying device 212, with straight and curved ducts 202, and branches 206, leading to adapted end pieces 207 for placing apparel 205 over by sliding 204 apparel over adapted piece of duct branch.

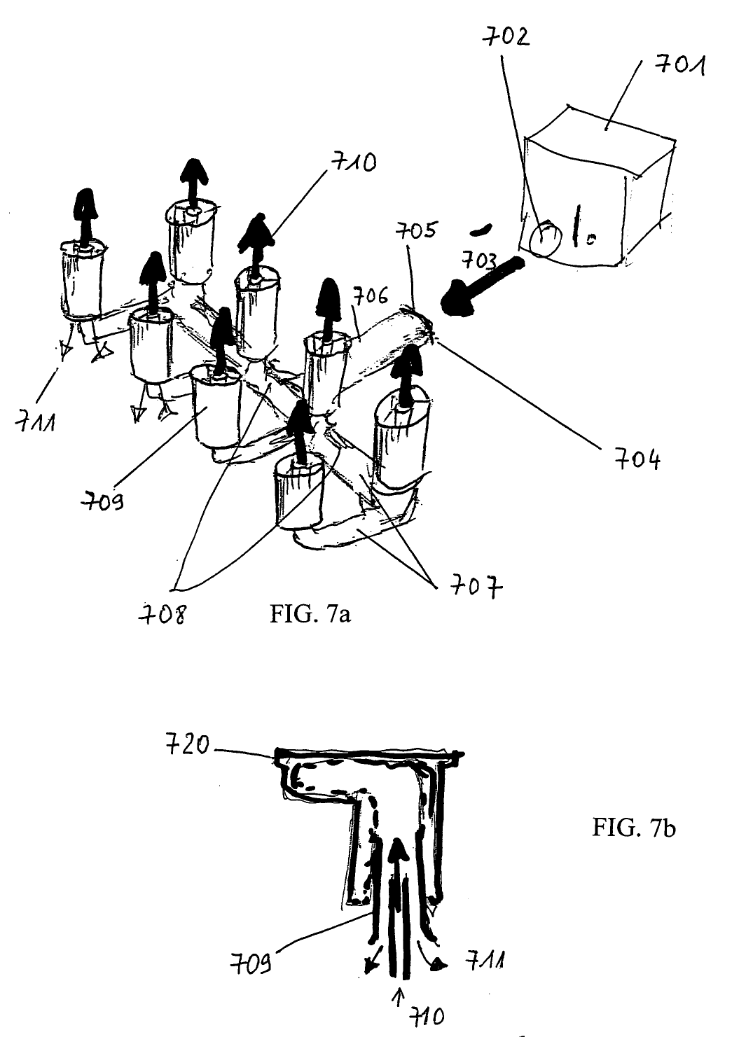

FIG. 7a illustrates HVAC unit with outlet (702) for air (703) of varying temperature and conditioning air, moisture content, main connector or coupling device 704, with or without joint 705 feeding conditioning air into main duct (706) and branches (707), (708). Stand (709) is provided for placing or locating material, equipment or apparel (not shown). Conditioning feed air (110) to be provided to material, equipment or apparel is shown. Return or exhaust air (711) is also provided.

FIG. 7b shows apparel, in this case, a boot (720) with stand (709), and conditioning feed air (710) entering boot and return air (711) exiting boot area. The present invention, via its preconditioning system, utilizes the heating and cooling capability of the HVAC to deliver hot, warm or cold or dried (air conditioned) air for purposes other that warming and cooling the cabin and or the passengers. In addition preferred embodiments of the present invention, the ducts and branches of the present invention could be extended to feeding or providing a cooler or cooler box that can be customized or more like a standard cool-box or cooler for goods, depending upon the specific needs of the end user. The conditioned air could be used to pre-condition perishables, for example, and keep them warm or cool during deliveries or pickups. Further, the present invention, in more of its more preferred embodiments, is adapted for ‘general’ thermal storage of medical supplies such as transplant organs or medicines

Though such a pre-conditioning system can be present at initial sale of a vehicle, the present invention also may be constructed after original sale of the vehicle. For example, the additional device necessary to form preferred embodiments of the present invention can be sold in the aftermarket as attachments or kits. In preferred embodiments, for example, the device that can be sold in such kits has ducts on the order of 5-25 cfm per square inch.

As described above, the rear HVAC unit is particularly preferred in preferred embodiments of the present invention. Rear HVAC units currently under production are typically capable of a dew-point of about 35° f. The thermal power available, after achieving the HVAC unit's primary goal of providing conditioned air to the passenger compartment, is, after the engine warm-up, still of the order of some 4-8 kW, i.e. of the order of a common US household clothes dryer.

Additionally, rear HVAC units in current production often have flow rates and control of air from about 50-250 scfm. This, too, is at a level comparable to a household clothes dryer.

The present invention, by utilizing, in its more preferred embodiments, the rear HVAC unit as part of its preconditioning system, with respect to power, flow, temperature and control, provides for efficient and effective preconditioning of materials, equipment and apparel, at a minimal overall cost to the end uses of the vehicle. The present invention, by providing for permanent, or detachable, or removable ducts, branches or conduits to deliver the appropriate air, provides for a pre-conditioning system that provides added comfort and value to the end user without significant cost.

What is claimed is:

1. A HVAC preconditioning system comprising:
at least one HVAC unit having at least one outlet for providing conditioning air that has been conditioned in the HVAC unit;
at least one device having at least one duct in functional communication with the at least one outlet for providing conditioning air;
at least one hole or opening in the at least one duct to provide for conditioning air to be released external to the device;
the at least one hole or opening positioned so that the conditioning air is released external to the device and provided to a material, equipment or apparel to condition the material, equipment or apparel.

2. An HVAC preconditioning system as in claim 1, wherein the at least one duct has at least one branch to provide conditioning air to a material, equipment or apparel.

3. An HVAC preconditioning system as in claim 1, wherein the HVAC unit is a rear HVAC unit.

4. An HVAC preconditioning system as in claim 3, wherein the HVAC unit is a rear unit and the device has a plurality of ducts.

5. An HVAC preconditioning system as in claim 3, wherein the at least one duct has at least one branch.

6. An HVAC preconditioning system as in claim 5, wherein the at least one duct has at least two branches.

7. An HVAC preconditioning system as in claim 5, wherein the at least one duct or the at least one branch is a multiple piece duct or branch.

8. An HVAC preconditioning system as in claim 6, wherein the at least one duct or the at least one branch has a stand.

9. An HVAC preconditioning system as in claim 5, wherein the HVAC preconditioning unit is found in a motor vehicle segment or class including multi-person carrier vehicle, sport utility vehicle or truck.

10. An HVAC preconditioning system as in claim 9, wherein the HVAC has a mode door with a sealing flap dedicated to providing conditioning are to the device.

11. An HVAC preconditioning system as in claim 5, wherein the ducts are made of plastic or resin like material and are blow-molded, injection molded, or the like.

12. An HVAC preconditioning system, as in claim 2, wherein the branch ends are situated such that apparel can be positioned, placed or pushed over the branches, and conditioning air can be provided to the apparel.

13. An HVAC preconditioning system, as in claim 12, wherein the conditioning air passes through or by the apparel and is exhausted outside of the preconditioning system.

14. A HVAC preconditioning system comprising:
at least one HVAC unit having at least one outlet for providing conditioning air that has been conditioned in the HVAC unit;
at least one device having at least one duct in functional communication with the at least one outlet for providing conditioning air;
at least one branch in communication with the at least one duct;
at least one hole or opening in the at least one duct or the at least one branch to provide for conditioning air to be released external to the device;
wherein the at least one hole or opening is positioned so that conditioning air is be provided to a material, equipment or apparel to condition the material, equipment or apparel, and wherein the majority of the conditioned air provided to the material, equipment or apparel subsequently is released external to both the device and the material, equipment or apparel.

15. An HVAC conditioning system as in claim 14, wherein the conditioning air, when released external to the material, equipment or apparel, takes with it moisture, dampness or wet air.

16. An HVAC preconditioning system as in claim 15, wherein the HVAC unit is a rear HVAC unit.

17. An HVAC preconditioning system as in claim 15, wherein the HVAC unit is a rear unit and the device has a plurality of ducts.

18. An HVAC preconditioning system as in claim 15, wherein the at least one duct or the at least one branch is a multiple piece duct or branch.

19. An HVAC preconditioning system as in claim 18, wherein the at least one duct or the at least one branch has a stand.

20. An HVAC preconditioning system as in claim 14, wherein the ducts are made of plastic or resin like material and are blow-molded, injection molded, or the like and wherein the duct or branch ends are situated such that apparel can be positioned, placed or pushed over the branches, and conditioning air can be provided to the apparel.
